(19) United States
(12) Patent Application Publication
(10) Pub. No.: US 2020/0233696 A1
(43) Pub. Date: Jul. 23, 2020

(54) Real Time User Matching Using Purchasing Behavior

(71) Applicant: Punchh, Inc., San Mateo, CA (US)

(72) Inventors: Vivek Jayan, Redwood City, CA (US); Kumar Ujjwal, East Palo Alto, CA (US); Andrew Daniel McElroy, San Jose, CA (US); Shyam Rao, San Carlos, CA (US)

(21) Appl. No.: 16/743,801

(22) Filed: Jan. 15, 2020

Related U.S. Application Data
(60) Provisional application No. 62/793,552, filed on Jan. 17, 2019.

(51) Int. Cl. G06F 9/46; G06F 9/445; G06F 21/62; G06F 9/54

(52) U.S. Cl. CPC G06F 9/466; G06F 9/541; G06F 21/6254; G06F 9/4451

(57) ABSTRACT

A system and a method are disclosed for disambiguating between anonymous users associated with multiple transactions. In an embodiment, a system receives information about a transaction and generates a profile of the anonymous user associated with the transaction. In response to another transaction, the system compares the transactions to determine whether the same anonymous user is associated with both transactions. Upon determining that the same anonymous user is associated both transactions, the system adds information about the new transaction to the profile of the anonymous user.

### CROSS REFERENCE TO RELATED APPLICATIONS

This application claims the benefit of U.S. Provisional Application No. 62/793,552, filed Jan. 17, 2019, the disclosure of which is hereby incorporated by reference herein in its entirety.

### TECHNICAL FIELD

The disclosure generally relates to the field of data management, and more specifically to disambiguating user-specific data.

### BACKGROUND

Profiling activity of users is commonplace on online systems, where user information enables systems to determine who is performing a particular activity, and to build a history of activities performed by the identified person. Online systems customize the online experience of each user based on the profiled activity. Physical locations do not have the benefit of being able to track activity of users, in that actions performed by the users at service providers are generally performed anonymously unless the users voluntarily take steps to be tracked (e.g., in exchange for some sort of benefit). Accordingly, customization of user experience at physical service providers on a per-user level has not been possible.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment including a transaction terminal, a client device, a server, and a network.

FIG. 2 illustrates one embodiment of a detailed view of modules within the transaction terminal.

FIG. 3 illustrates one embodiment of purchasing behavior recorded by a data collection module within the transaction terminal.

FIG. 4 illustrates a block diagram including components of an example machine able to read instructions from a machine-readable medium and execute them in a processor (or controller).

FIG. 5 illustrates one embodiment of a process for performing user matching using purchasing behavior.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium relates to identifying a same user across multiple transaction activities at a physical location. A system identifies, from transaction data, when the same anonymous user performs another transaction at the physical location.

For example, a user might have a habit of obtaining an item using a same transaction tool, such as a mobile wallet item, on a regular basis. While the physical location in which the transaction occurs may not have information that identifies the user, a processor (e.g., of a point of sale terminal or a peripheral thereto) may identify that it is the same anonymous user performing each transaction attempt, and may customize the user's experience (e.g., by customizing an output of the transaction terminal) notwithstanding that the user is anonymous.

In one embodiment, receiving processor receives, in connection with a first transaction by an anonymous user at a transaction terminal, a first object identifier and a first transaction tool information. The processor generates a profile for the anonymous user, the profile including the first transaction tool information and the first object identifier. The processor detects a second transaction relating to a second object identifier using the transaction terminal, where the second transaction is made using a second transaction tool. The processor determines whether the second transaction was performed by the same anonymous user as the first transaction, in response to which, the second object identifier is added to the profile of the anonymous user.

In another embodiment, a non-transitory computer readable storage medium comprises computer executable code that when executed by one or more processors causes the processors to perform operations. The processors (e.g., of a point of sale terminal or a peripheral thereto) receive, in connection with a first transaction by an anonymous user using a transaction terminal, a first object identifier and a first transaction tool information. The processors generate a profile for the anonymous user, the profile including the first transaction tool information and the first object identifier. The processors detect a second transaction relating to a second object identifier using the transaction terminal, where the second transaction is made using a second transaction tool. The processors determine whether the second transaction was performed by the anonymous user, in response to which, the processors add the second object identifier to the profile of the anonymous user.

### Transaction Terminal System Environment

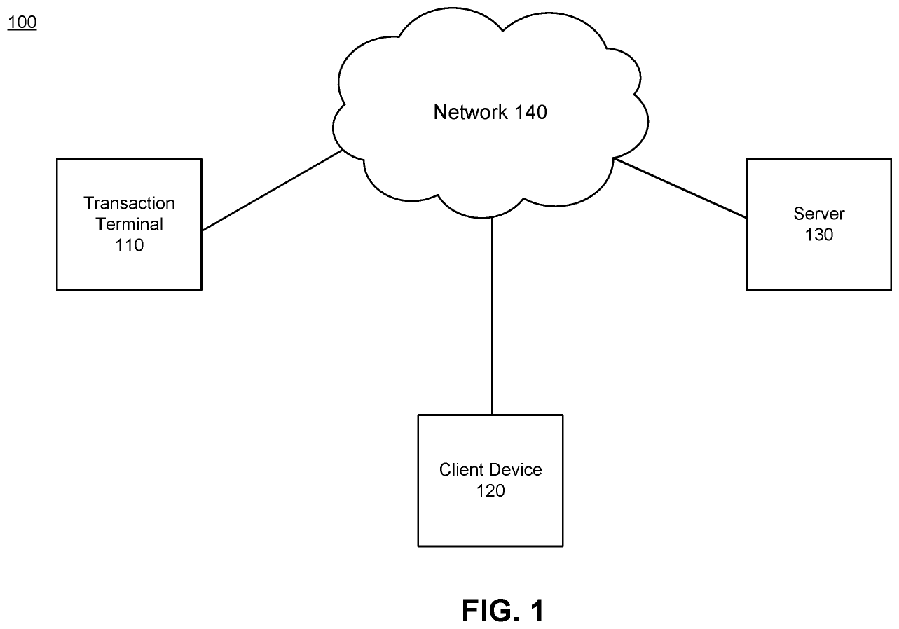

FIG. 1 illustrates one embodiment of a system environment 100 including a transaction terminal 110, a client device 120, a server 130, and a network 140. Within the system environment 100, transaction terminal 110 may process a transaction of a user (e.g., a purchase an object), at the transaction terminal 110. In order to process the transaction, transaction terminal 110 detects a transaction tool of the user. Transaction terminal 110 obtains information about the first transaction occurring at the transaction terminal 110, including objects purchased and information about the transaction tool, and provides the information to the server 130 over the network 140.

The transaction terminal 110 may be physically located in a store that processes a transaction whereby a user obtains a physical object or provides consideration for a provided service. For example, the transaction terminal 110 may be a point of sale terminal used to transfer ownership of a physical object to a person. During such transactions, the transaction terminal does not typically identify an identity of a purchasing user. The transaction terminal 110 detects the user's transaction tool. The term transaction tool, as used herein, refers to a tool used to provide consideration for obtaining a physical object. Transaction tools may be physical or virtual. Examples of physical transaction tools include physical credit cards, debit cards, charge cards, gift cards, loyalty redemption cards, and the like. Examples of virtual transaction tools include virtual credit cards, debit cards, charge cards, gift cards, loyalty redemption cards, and the like, which may form part of an electronic wallet (e.g., APPLE PAY, ANDROID PAY, etc.). Transaction tools typically include a number (e.g., a credit card number) for identifying an account, and also typically include a name of a user. This may be printed on the card (whether physical or virtual), or may be encoded (e.g., in a bar code, a QR code, or similar). The system environment 100 may include a plurality of transaction terminals.

The client device 120 provides information about the user to the transaction terminal 110 and/or the server 130. The client device 120 may be a smartphone, a wearable device (e.g., smart watch), and/or an Internet of Things device. In some embodiments, the client device 120 may couple to a digital wallet that includes one or more virtual transaction tools. The client device 120 may facilitate de-anonymizing the user. For example, the client device 120 may prompt the user to confirm their identity and/or provide the user with recommendations regarding products for future transactions.

The transaction terminal 110 provides information about the transaction and the client device 120 to the server 130, over the network 140. The server 130 includes a database that stores information about transactions (e.g., the transaction at the transaction terminal 110) and transaction tools used. In some embodiments, the server 130 receives and stores information from a plurality of transaction terminals, in addition to the transaction terminal 110. The server may be physically co-located with transaction terminal 110. In some embodiments, the server is cloud-based.

The network 140 transmits data from the transaction terminal 110 and the client device 120 to the server 130. The network 140 may be a local area and/or wide area networks using wireless and/or wired communication systems, such as the Internet. In some embodiments, the network 140 may transmit data over a single connection (e.g., a data component of a cellular signal, WiFi, among others) and/or over multiple connections (e.g., transaction terminal information via GPS, while transaction tool information via data networks). The network 140 may include encryption capabilities to ensure the security of consumer data. For example, encryption technologies may include secure sockets layer (SSL), transport layer security (TLS), virtual private networks (VPNs), Internet Protocol security (IPsec), etc.

User Identification and Disambiguation within the Transaction System Environment

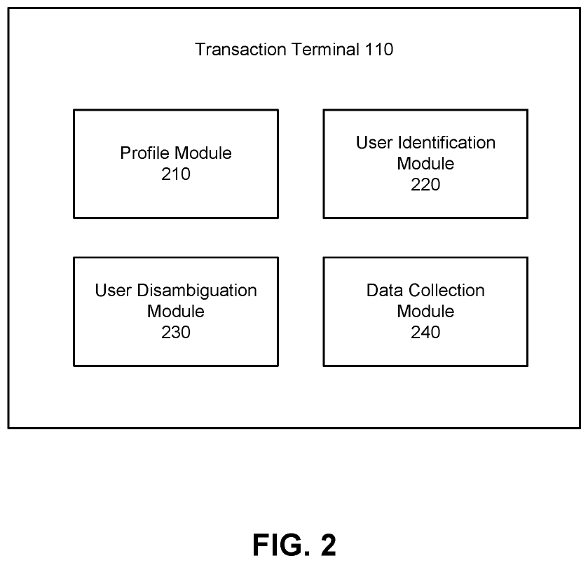

FIG. 2 illustrates one embodiment of a detailed view of modules within the transaction terminal 110. The transaction terminal 110 may perform user matching between transactions to determine whether the same anonymous user has performed a plurality of transactions at the transaction terminal 110. The transaction terminal 110 includes a profile module 210, a user identification module 220, a user disambiguation module 230, and a data collection module 240. In some embodiments, the user identification module 220 and the user disambiguation module 230 may be combined. In some embodiments, the server 130 of FIG. 1 performs user matching in addition to and/or instead of the transaction terminal 110. Accordingly, a subset of the modules described in FIG. 2 may be found within the server 130.

In response to detecting a transaction by an anonymous user, the transaction terminal 110 obtains identifying information about the anonymous user and checks for a profile that matches the anonymous user. If a matching profile is found (e.g., by the user identification module 220, to be described in further detail below), the profile module 210 adds information about the transaction to the anonymous user's profile. If no matching profile is found, the profile module 210 creates a profile for the anonymous user associated with the transaction.

The profile module 210 generates the anonymous user profile using some or all transaction tool information of a transaction tool used to obtain the physical object. Transaction tool information stored to the user profile includes a user identifier (e.g., the user's name) and/or a transaction tool identifier (e.g., a subset of the credit card number). For example, the transaction tool identifier may be the last four digits of the user's credit card number (e.g., because the remainder of the credit card number may be masked for security or privacy reasons). In some embodiments, the profile module 210 obtains transaction tool information from the client device 120 of the user when the transaction terminal 110 detects a transaction tool coupled to the client device 120. The profile module 210 also adds information about the transaction to the profile of the user. The transaction information may include object identifiers specifying objects bought during the transaction (e.g., stock keeping units (SKUs)), a date and/or a time of the transaction, or some combination thereof. The profile of the anonymous user may include information other than what is described herein. In some embodiments, when the transaction tool information of the anonymous user matches that stored in a pre-existing user profile, the profile module 210 adds the transaction information to the anonymous user profile. The generated profile of the anonymous user may be stored at the transaction terminal 110 and/or the server 130.

The user identification module 220 identifies the anonymous user performing the transaction. The user identification module 220 identifies and compares transaction tool information associated with the transaction against transaction tool information in stored user profiles. As described above, the profile module 210 generates the user profiles, which are associated with previous transactions by anonymous users. After finding a match between the transaction tool information of the transaction and a stored user profile, the user identification module 220 identifies the anonymous user as associated with the stored user profile (e.g., the same anonymous user). In some embodiments, to confirm that the transactions were performed by the same anonymous user, the user identification module 220 provides the transaction tool information and the transaction information to the user disambiguation module 230.

The user identification module 220 may find a partial profile match, where only of the transaction tool identifier and the user identifier match the transaction tool information in a stored user profile. When the user identification module 220 finds a partial profile match, criteria set by an administrator of the transaction terminal 110 determines whether the user identification module 220 determines that the transactions were performed by the same anonymous user. For example, in one embodiment, the user identification module 220 identifies the same anonymous user if the partial profile match occurred against a stored user profile generated within the last 90 days of the transaction. In another embodiment, the user identification module 220 provides the transaction tool information and transaction information to the user disambiguation module 230 after determining a partial profile match. In some embodiments, the user identification module 220 may determine no match between the transaction tool information and stored user profiles and subsequently determines that the same anonymous user did not perform any previous transactions.

The user disambiguation module 230 determines whether two transactions were performed by the same anonymous user. While the user identification module 220 may determine a match and/or a partial match between the transaction tool information and that in the stored user profile, in some cases, two different users with similar names and/or transaction tool identifiers may exist. For example, transaction tool information for two different users may include identical names, and identical transaction tool identifier information (e.g., where only the last four digits of a credit card are collected by transaction terminal 110, these may be identical as well). In some embodiments, the same anonymous user may use different transaction tools, e.g., with different last four digits, for different transactions. Accordingly, the system cannot solely rely on transaction tool information to determine whether the same anonymous user is performing two transactions.

The user disambiguation module 230 uses the transaction information to disambiguate between users found to have at least partial matching transaction tool information by the user identification module 220. In some embodiments, the user disambiguation module 230 considers the time at which the transactions occurred, similarity between objects acquired, and/or a frequency of an object bought during each transaction by the anonymous user.

In some embodiments, the user disambiguation module 230 compares and determines a match between the times at which each transaction occurred. Transaction times may match when they occur at the same time on multiple days. For example, a transaction may occur at 10 AM and another may occur at 10 AM the next day. In some embodiments, transaction times may match when the transactions occur within a threshold amount of time relative to when the first transaction is performed. For example, if the threshold amount of time is set to be 1 hour and the first transaction occurs at 10 AM, while the second transaction occurs at 10:25 AM on the next day, the transaction times match. In some embodiments, the transaction terminal 110 and/or the server 130 determine what constitutes a matching transaction time.

The user disambiguation module 230 also considers the similarity between objects bought during the transactions, based on the object identifiers stored in the profile of the user. A relational database, stored on the transaction terminal 110 and/or at the server 130, may delineate similarity between objects. In some embodiments, the relational database indicates similarity between objects based on product types (e.g., breakfast foods, beverages, frozen desserts) and/or object identifiers.

In other embodiments, the user disambiguation module 230 accounts for a frequency of an object bought over a period of time. For example, the user disambiguation module 230 may determine that orange juice is performed by the anonymous user every day.

The user disambiguation module 230 applies a weight to each determined match of transaction information to determine a probability that two transactions were performed by the same anonymous user. Equation (Eq.) 1 below describes a customer probability algorithm that the user disambiguation module 230 may use.

P=(W₁*A)+(W₂*B)+(W₃*C)+(W₄*D)+ . . . (1)

Eq. 1 describes a probability, P, that the same anonymous user performed both transactions. A, B, C, and D describe a match between the transaction tool information and the transaction information. For example, A may be matching user identifiers, B may be matching transaction tool identifiers, C may be a matching time of transaction, and D may be matching object identifiers. In some embodiments, Eq. 1 accounts for other transaction information, such as matches between object types, in addition to those described herein. Matching transaction information is weighted by W₁, W₂, W₃, and W₄, and so on, which indicates how important a match with regards to certain transaction information. An administrator of the transaction terminal 110 and/or the server 130 may determine the weights W₁, W₂, W₃, and W₄. The user disambiguation module 230 aggregates the weighted matching information to determine a probability that the same anonymous user performed both transactions. The user disambiguation module 230 may confirm that the same anonymous user performed both transactions when the probability is over a threshold. For example, a 60% probability may be sufficient to determine that the users match. In some embodiments, the threshold probability and the weights applied to the matching transaction tool information vary per transaction tool, object sold, and/or transaction tool 110 administrator.

For example, in comparing two transactions, the user disambiguation module 230 may determine a match between the user identifiers and object types, but no match for the transaction tool identifiers and the time of the transactions. The administrator of the transaction terminal 110 may deem matching transaction tool identifiers as critical for determining that the same anonymous user performed both transactions, and thus weigh matching transaction tool identifiers more heavily than matching user identifiers. Accordingly, the user disambiguation module 230 may output a lower probability that the same anonymous user performed both transactions.

As mentioned above, upon determining that the same anonymous user performed both transactions, the profile module 210 adds the new transaction tool information and/or the new transaction information to the stored profile of the anonymous user.

The data collection module 240 collects purchasing behavior data about users. The data collection module 240 may store the profile of the anonymous user generated by the profile module 210 and/or information about the transactions. In some embodiments, the data collection module 240 further collects information about the same anonymous user determined to have performed multiple transactions. Once the user disambiguation module 230 outputs a probability that indicates the same anonymous user has performed the transactions, the transaction terminal 110 may collect more information about the anonymous user. The data collection module 240 may, for example, seek confirmation from the anonymous user that they did perform multiple transactions. For example, in some embodiments, the data collection module 240 may display and/or print a Quick Response (QR) code on a token memorializing a transaction (e.g., a receipt) by the anonymous user, prompting the anonymous user to identify themselves. In some embodiments, the data collection module 240 incentivizes the anonymous user to provide more information about themselves via a loyalty and/or membership program. For example, the data collection module 240 may provide recommendations to the anonymous user, in response to the anonymous user confirming their identity. In some embodiments, the recommendations may include suggested objects for purchase relating to previous transactions by the anonymous user. The data collection module 240 may provide the recommendations on the client device 120 and/or a token memorializing a transaction. In some embodiments, the data collection module 240 presents the recommendation to the user in response to detecting that a previously used transaction tool is used again. In some embodiments, the recommendation may be an offer presented to the user, which the user may redeem by scanning a QR code presented in conjunction with the recommendation. After detecting that the user redeemed the offer, the transaction tool 110 may confirm the user's identity. In some embodiments, the data collection module 240 may provide the user data to the server 130.

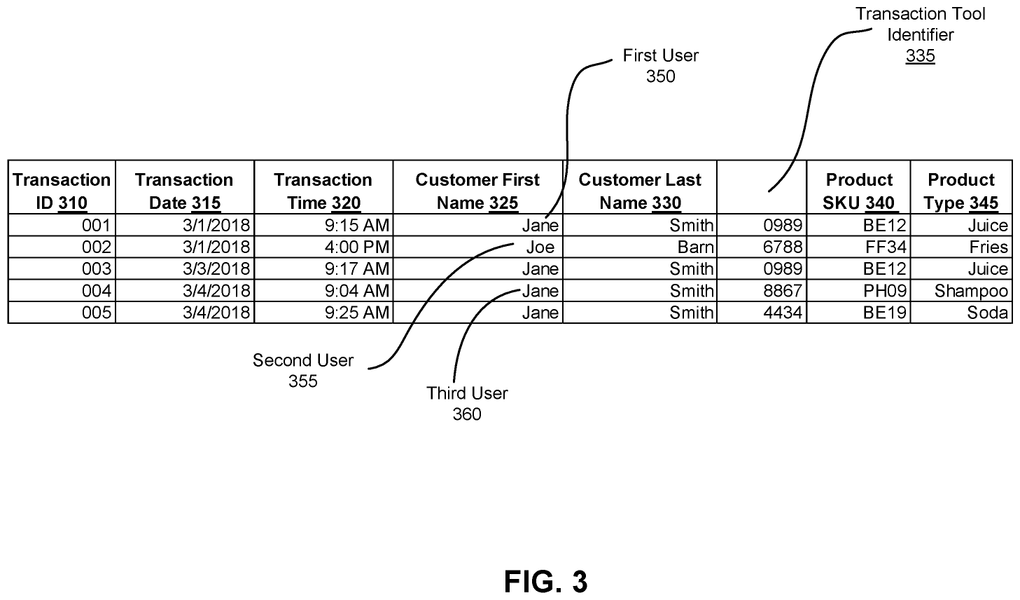

FIG. 3 illustrates one embodiment of purchasing behavior recorded by the data collection module 240 within the transaction terminal 110. Every transaction is identified by a transaction ID 310, and for each transaction, the data collection module 240 tracks a transaction date 315, a transaction time 320, a customer first name 325, a customer last name 330, a transaction tool identifier 335, a product stock keeping unit (SKU) 340, and a product type 345. The transaction tool identifier 335 may be the last four digits of a credit card, as depicted in FIG. 3. The product SKU is an embodiment of an object identifier. The data collection module 240 may store information other than what is described herein.

The data shown in FIG. 3 relates to a first user 350, a second user 355, and a third user 360. The first user 350, named Jane Smith, conducts a first transaction 001 on Mar. 1, 2018 at 9:15 AM. Jane Smith's transaction tool identifier 335 is recorded as 0989. Jane Smith purchases a juice with an identifier BE12. A transaction 003 performed on Mar. 3, 2018 at 9:17 AM indicates that a second user, also named Jane Smith, with the same transaction tool identifier, 0989, purchased the same juice BE 12. The user identification module 220, as described in FIG. 2, determines a match between the name and transaction tool identifier of the user. Subsequently, the user disambiguation module 230 takes, as input, information about transactions 001 and 003, to determine a probability that both transactions were performed by the same Jane Smith, who is the first user 350.

Transaction 004 is also performed by a Jane Smith, but the transaction tool identifier recorded is 8867. Furthermore, transaction 004 is associated with a shampoo with an SKU of PH09. The user identification module 220 determines a match between the name Jane Smith between the transactions 001, 003, and 004, but determines there is no match between the transaction tool identifiers. The user disambiguation module 230 determines that while a match in the time of the transactions may exist, the object type and identifiers between transaction 001, 003, and 004 also do not match. The user disambiguation module 230 may weigh matches between product identifiers more than transaction times and therefore output a low probability that transaction 004 was performed by the same Jane Smith as in transactions 001 and 003. Thus, the user disambiguation module 230 may determine that transaction 004 is not performed by the first user 350. Rather, the transaction 004 is performed by a third user 360.

Transaction 005 is performed by a Jane Smith with a different transaction tool identifier, 4434, and is associated with a soda with an SKU of BE19. Comparing transactions 001 and 005, the user identification module 220 determines a match between the name, but no match between the transaction tool identifiers. The user disambiguation module 230 determines that the product identifiers do not match, but determines, as per data stored in a relational database, that the product type is similar (e.g., soda is similar to juice). Additionally, a time of the transaction 001 matches the time of the transaction 005. The user disambiguation module may weight the matching time and product type more heavily than the fact that the transaction tool identifiers do not match. Accordingly, the user disambiguation module determines a match between the user performing transaction 001 and 005: the first user 350.

The transaction 002 occurs at 4 PM and is associated with a customer named Joe Barn. The user identification module 220 may determine no match between the name and transaction tool identifier of the first transaction 001 and the second transaction 002. Accordingly, the user identification module 220 may determine that the same user did not perform both transactions. Thus, transaction 002 may be conducted by the second user 355.

### Computing Machine Architecture

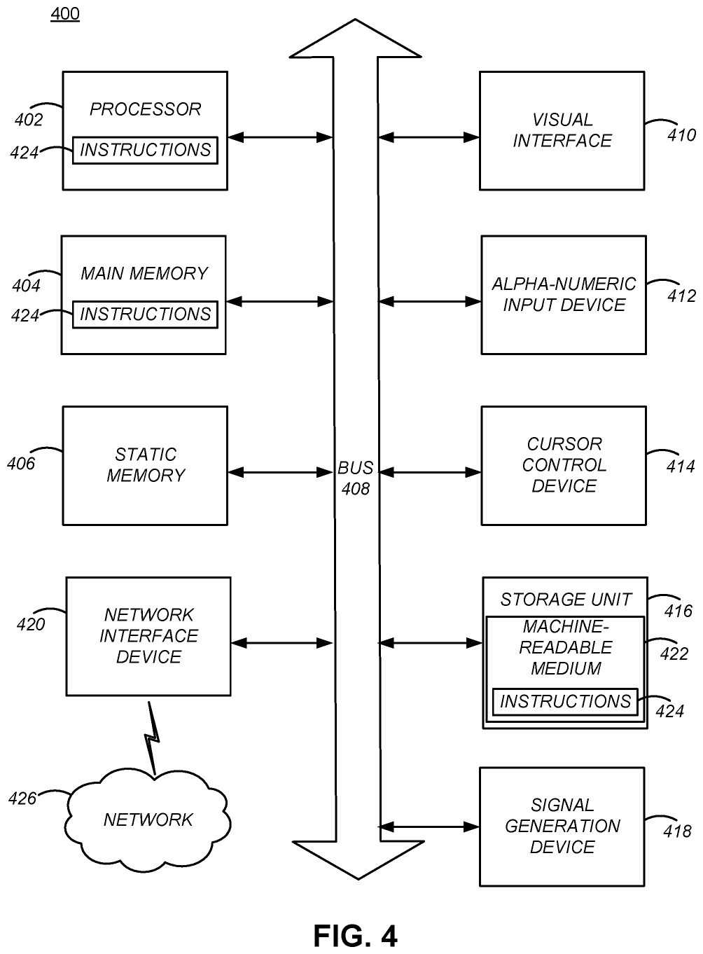

FIG. 4 illustrates a block diagram including components of an example machine able to read instructions from a machine-readable medium and execute them in a processor (or controller). Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### User Matching Between Transactions

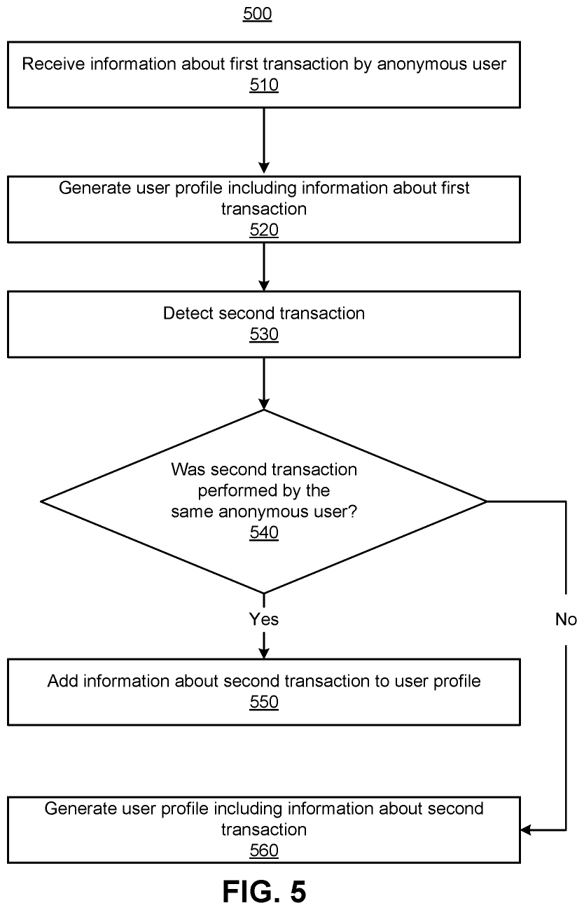

FIG. 5 illustrates one embodiment of a process 500 for performing user matching using purchasing behavior. Process 500 is performed by a transaction terminal (e.g., the transaction terminal 110) and/or a server (e.g., the server 130). The transaction terminal receives 510 information about a first transaction (e.g., the transaction ID 001) performed by an anonymous user. The first transaction information may include a user identifier (e.g., the customer first name 325 and the customer last name 330), a transaction tool identifier (e.g., the transaction tool identifier 335), and a time of the transaction (e.g., the transaction time 320). Additionally, the first transaction information may include a first object identifier (e.g., the product SKU 340) specifying the first object purchased and a product type (e.g., the product type 345) characterizing the first object.

The transaction terminal generates 520 a user profile (e.g., using the profile module 210) associated with the first transaction, including the first transaction information.

The transaction terminal detects 530 a second transaction (e.g., the transaction ID 002) and receives information about the second transaction. The second transaction information may include the user identifier, transaction tool identifier, transaction time, a second object identifier, and a second object type associated with the second transaction.

The transaction terminal determines 540 whether the second transaction was performed by the same anonymous user. The transaction terminal identifies (e.g., by the user identification module 220) a potentially matching user, where the profiles of the anonymous users associated with the first and second transactions, respectively, have matching user identifiers and/or transaction tool identifiers. The transaction terminal disambiguates the potentially matching users by determining further matches between the first and second transaction information. Weighing matching information, the transaction tool outputs a probability that both transactions were by the same anonymous user. When the probability crosses a threshold, the transaction terminal indicates that the same anonymous user performed both transactions.

Upon confirming that the second transaction was performed by the same anonymous user, the transaction terminal adds 550 information about the second transaction to the anonymous user's profile. In some embodiments, the transaction terminal provides recommendations to the anonymous user based on the information stored on the profile. The recommendations may be for products similar to those purchased in the first and/or second transactions, for example. The transaction terminal may provide the recommendations to the user via a client device (e.g., the client device 120) and/or a token memorializing a transaction (e.g., a receipt) at the transaction terminal.

Upon determining that the second transaction is not performed by the same anonymous user, the transaction terminal generates 560 a new anonymous user profile with information about the second transaction.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for disambiguating user data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, in connection with a first transaction by an anonymous user using a transaction terminal, a first object identifier and a first transaction tool information;
generating a profile for the anonymous user, the profile including the first transaction tool information and the first object identifier;
detecting, using the transaction terminal, a second transaction relating to a second object identifier made using a second transaction tool;
determining whether the second transaction was performed by the anonymous user; and
responsive to determining that the second transaction was performed by the anonymous user, adding the second object identifier to the profile of the anonymous user.

2. The method of claim 1, wherein determining whether the second transaction was performed by the anonymous user comprises:
comparing the first transaction and the second transaction, the comparing comprising determining whether the first transaction tool matches the second transaction tool; and
responsive to determining that the first transaction tool matches the second transaction tool, determining that the second transaction was performed by the anonymous user.

3. The method of claim 2, wherein determining whether the first transaction tool matches the second transaction tool comprises:
determining a user identifier and a transaction tool identifier associated with each of the first and second transaction tools;
responsive to determining that the user identifier and the transaction tool identifier associated with each of the first and second transaction tools are the same, determining that the first transaction tool matches the second transaction tool.

4. The method of claim 2, wherein comparing the first transaction and the second transaction further comprises:
determining whether a time at which the first transaction occurred matches a time at which the second transaction occurred.

5. The method of claim 4, wherein comparing the first transaction and the second transaction further comprises:
applying a weight to determining that the first transaction tool matches the second transaction tool;
applying a second weight to determining that the time at which the first transaction occurred matches the time at which the second transaction occurred;
determining, based on the applied weights, a probability that the second transaction was performed by the anonymous user.

6. The method of claim 1, wherein determining whether the second transaction was performed by the anonymous user occurs at the transaction terminal.

7. The method of claim 1, wherein determining whether the second transaction was performed by the anonymous user occurs at a server.

8. The method of claim 1, further comprising:
responsive to determining that the second transaction was performed by the anonymous user, identifying a third object relating to the first object and the second object;
providing a recommendation including the third object to the anonymous user.

9. The method of claim 8, wherein the anonymous user accesses the recommendation via a client device.

10. The method of claim 8, wherein the recommendation is provided to the anonymous user in response to a use of the first transaction tool or the second transaction tool in a third transaction.

11. The method of claim 8, wherein the recommendation is provided to the anonymous user via a token memorializing the second transaction.

12. A non-transitory computer readable storage medium comprising computer executable code that when executed by one or more processors causes the one or more processors to perform operations comprising:
receiving, in connection with a first transaction by an anonymous user using a transaction terminal, a first object identifier and a first transaction tool information;
generating a profile for the anonymous user, the profile including the first transaction tool information and the first object identifier;
detecting, using the transaction terminal, a second transaction relating to a second object identifier made using a second transaction tool;
determining whether the second transaction was performed by the anonymous user; and
responsive to determining that the second transaction was performed by the anonymous user, adding the second object identifier to the profile of the anonymous user.

13. The computer readable storage medium of claim 12, wherein determining whether the second transaction was performed by the anonymous user comprises:
comparing the first transaction and the second transaction, the comparing comprising determining whether the first transaction tool matches the second transaction tool; and
responsive to determining that the first transaction tool matches the second transaction tool, determining that the second transaction was performed by the anonymous user.

14. The computer readable storage medium of claim 13, wherein determining whether the first transaction tool matches the second transaction tool comprises:
determining a user identifier and a transaction tool identifier associated with each of the first and second transaction tools;
responsive to determining that the user identifier and the transaction tool identifier associated with each of the first and second transaction tools are the same, determining that the first transaction tool matches the second transaction tool.

15. The computer readable storage medium of claim 13, wherein comparing the first transaction and the second transaction further comprises:
determining whether a time at which the first transaction occurred matches a time at which the second transaction occurred.

16. The computer readable storage medium of claim 15, wherein comparing the first transaction and the second transaction further comprises:
applying a weight to determining that the first transaction tool matches the second transaction tool;
applying a second weight to determining that the time at which the first transaction occurred matches the time at which the second transaction occurred;
determining, based on the applied weights, a probability that the second transaction was performed by the anonymous user.

17. The computer readable storage medium of claim 12, wherein determining whether the second transaction was performed by the anonymous user occurs at the transaction terminal.

18. The computer readable storage medium of claim 12, wherein determining whether the second transaction was performed by the anonymous user occurs at a server.

19. The computer readable storage medium of claim 12, wherein the operations further comprise:
responsive to determining that the second transaction was performed by the anonymous user, identifying a third object relating to the first object and the second object;
providing a recommendation including the third object to the anonymous user.

20. The computer readable storage medium of claim 19, wherein the recommendation is provided to the anonymous user in response to a use of the first transaction tool or the second transaction tool in a third transaction.
